(19) United States
(12) Patent Application Publication
(10) Pub. No.: US 2018/0268172 A1
(43) Pub. Date: Sep. 20, 2018

(54) ELECTRONIC DEVICE AUTHENTICATION SYSTEM

(71) Applicant: Massachusetts Institute of Technology, Cambridge, MA (US)

(72) Inventors: Eric Alan Koziel, Lexington, MA (US); Lauren E. Milechin, Acton, MA (US); Mankuan Michael Vai, Sudbury, MA (US); Roger I. Khazan, Arlington, MA (US)

(21) Appl. No.: 15/458,083

(22) Filed: Mar. 14, 2017

(51) Int. Cl. G06F 21/70; G06K 9/00; G06K 9/62

(52) U.S. Cl. CPC G06F 21/70; G06K 9/6218; G06K 9/00536; G06K 9/0053

(57) ABSTRACT

A method for determining an authenticity of a configurable electronic device includes configuring the configurable electronic device according to stimulus data, measuring one or more side-effects of operation of the configurable electronic device after configuration of the electronic device to generate representations of the one or more side-effects, processing the representations of the side-effects using a feature extraction module to determine one or more features characterizing the representations of the side-effects, and processing the one or more features characterizing the representations of the side-effects using an authentication module to determine a degree of authenticity of the configurable electronic device.

### STATEMENT AS TO FEDERALLY SPONSORED RESEARCH

This invention was made with government support under Contract No. FA8721-05-C-0002, Program No. 2643 awarded by Defense Microelectronics Activity. The Government has certain rights in the invention.

### BACKGROUND

This invention relates to authentication of electronic devices using side-channel information.

The prevalence of counterfeit microelectronics in government and commercial supply chains poses a significant threat to the reliability of electronic systems, especially sensitive government electronic systems. In general, counterfeit microelectronics include electronic components that are misrepresented in sale. Some examples of types of counterfeit microelectronics include remarked parts, reproduced or “cloned” parts, and recycled parts that have been used in prior systems. The sophistication of counterfeits can vary from simple re-etching and blacktopping to full netlist-level reproduction of parts.

Some organizations such as the Department of Defense now mandate that organizations and contractors proactively detect and avoid counterfeit parts. Many conventional techniques for detection of counterfeit parts are prohibitively expensive, time consuming, or destructive and therefore don't scale to a full acquisitions supply chain.

Some approaches to prevent counterfeiting include adding dielets to microelectronic parts that assert the authenticity of the parts. Other approaches add physically unclonable function (PUF) circuitry to microelectronic parts to ensure that the parts can be uniquely identified. These approaches are particularly useful for ensuring that parts can be authenticated in the future, but can not be used to identify parts that were produced in the past.

### SUMMARY

Conventional anti-counterfeiting approaches generally require manufacturer participation, incur additional overhead cost to execute, and are difficult to apply to parts produced in the past. Instead of leveraging additional components to assert identity, aspects described herein utilize physical phenomena manifesting from device operation (i.e., side-channel or side-effect information) to determine an authenticity of the device. Such techniques can be used to detect misrepresented parts regardless of manufacturer participation.

Certain aspects described herein utilize features derived from power signals provided to electronic devices to authenticate the devices. In particular, given a number of examples of known-authentic electronic devices and optionally examples of a known non-authentic electronic device, an authentication module (e.g., a classifier) is trained to provide an authentication result, for example a degree of authenticity of a particular device, or to distinguish between authentic and non-authentic devices. In some embodiments, the authentication module uses features derived from the power signals provided to the device. Features derived from a power signal of an electronic device with an unknown authenticity are processed by the authentication module to determine whether the electronic device is authentic (or a measure of confidence that the electronic device is authentic).

In some examples, the features include statistical measures (e.g., the mean, variance, kurtosis, and skewness) calculated from the instantaneous frequency, phase, and amplitude of the power signal. The various features may be computed for the entirety of the signal or may be repeatedly computed for only part of the signal (e.g., for different clock cycles).

Given a large number of features, the features may be processed to reduce the number of features to include only those that contribute significantly to correct authentication results. In some examples, processing of a single feature is sufficient to generate a correct authentication result.

In a general aspect, a method for determining an authenticity of a configurable electronic device includes configuring the configurable electronic device according to stimulus data, measuring one or more side-effects of operation of the configurable electronic device after configuration of the electronic device to generate representations of the one or more side-effects, processing the representations of the side-effects using a feature extraction module to determine one or more features characterizing the representations of the side-effects, and processing the one or more features characterizing the representations of the side-effects using an authentication module to determine a degree of authenticity of the configurable electronic device.

Aspects may include one or more of the following features.

The authentication module may be configured to determine the degree of authenticity of the configurable electronic device according to corresponding features characterizing the representations of the side-effects of one or more other configurable electronic devices with known degrees of authenticity. The method may include training the authentication module including configuring the one or more other configurable electronic devices according to the stimulus data, measuring one or more side-effects of operation of the one or more other configurable electronic devices to generate corresponding representations of the side-effects, processing the corresponding representations of the side-effects using the feature extraction module to determine features characterizing the corresponding representations of the side-effects, and configuring the authentication module according to the features characterizing the corresponding representations of the side-effects and the known degrees of authenticity associated with the one or more other configurable electronic devices.

The authentication module may include a classifier configured to classify the configurable electronic device as being either authentic or inauthentic. The degree of authenticity may include an indication of a confidence that the configurable electronic device is authentic. The feature extraction module may be configured to extract a first set of features characterizing the representations of the side-effects and to determine the one or more features characterizing the representations of the side-effects as a subset of the first set of features. The subset of the first set of features may be determined by performing one or both of principal component analysis and a multiple cluster feature selection on the first set of features.

The representations of the one or more side-effects may include a power signal representing an operating power of the configurable electronic device. The feature extraction module may be configured to extract a first set of features characterizing the power signal and to determine the one or more features characterizing the power signal as a combination of features from the first set of features. The one or more features characterizing the power signal may include one or more of an instantaneous frequency of some or all of the power signal, a mean instantaneous frequency of some or all of the power signal, a variance of the instantaneous frequency of some or all of the power signal, a kurtosis of the instantaneous frequency of some or all of the power signal, and a skewness of the instantaneous frequency of some or all of the power signal, an instantaneous amplitude of some or all of the power signal, a mean instantaneous amplitude of some or all of the power signal, a variance of the instantaneous amplitude of some or all of the power signal, a kurtosis of the instantaneous amplitude of some or all of the power signal, and a skewness of the instantaneous amplitude of some or all of the power signal, an instantaneous phase of some or all of the power signal, a mean instantaneous phase of some or all of the power signal, a variance of the instantaneous phase of some or all of the power signal, a kurtosis of the instantaneous phase of some or all of the power signal, and a skewness of the instantaneous phase of some or all of the power signal.

Configuring the configurable electronic device according to the stimulus data may include configuring the configurable electronic device to perform a plurality of operations. The plurality of operations may include some or all of memory operations, register operations, and logic operations. Configuring the configurable electronic device to perform the plurality of operations may include configuring the configurable electronic device to perform a predefined number of iterations of a first set of operations. Configuring the configurable electronic device according to the stimulus data may include provisioning the configurable electronic device according to a hardware configuration specification.

The one or more side-effects of operation of the configurable electronic device may include temperature based side-effects. The one or more side-effects of operation of the configurable electronic device may include electromagnetic based side-effects. The method may include receiving the stimulus data from a remotely located, centralized stimulus data server. The one or more other configurable electronic devices may be known to be authentic. The authentication module may include a one-class support vector machine trained according to the one or more other configurable electronic devices.

In another general aspect, a system for determining an authenticity of a configurable electronic device includes an input for receiving stimulus data, an interface for configuring the configurable electronic device according to the stimulus data, on or more sensors for measuring one or more side-effects of operation of the configurable electronic device after configuring the electronic device to generate representations of the one or more side-effects, a feature extraction module for processing the representations of the side-effects to determine one or more features characterizing the representations of the side-effects, and an authentication module for processing the one or more features characterizing the representations of the side-effects to determine a degree of authenticity of the configurable electronic device.

Aspects may have the following advantages.

Unlike conventional device authentication systems, aspects enable authentication of electronic devices that are already manufactured and deployed. This is at least in part due to the fact that aspects do not require inclusion of any specialized hardware features in the electronic devices.

Other features and advantages of the invention are apparent from the following description, and from the claims.

### DESCRIPTION OF DRAWINGS

FIG. 1 is an authentication system.

FIG. 2 is an operational loop of a stimulus.

FIG. 3 shows a number of features derived from a side-channel response.

FIG. 4a is an authentic vs. non-authentic decision tree.

FIG. 4b is an authentic vs. authentic decision tree.

FIG. 5 is the authentication system in a training mode.

### DESCRIPTION

### 1System Overview

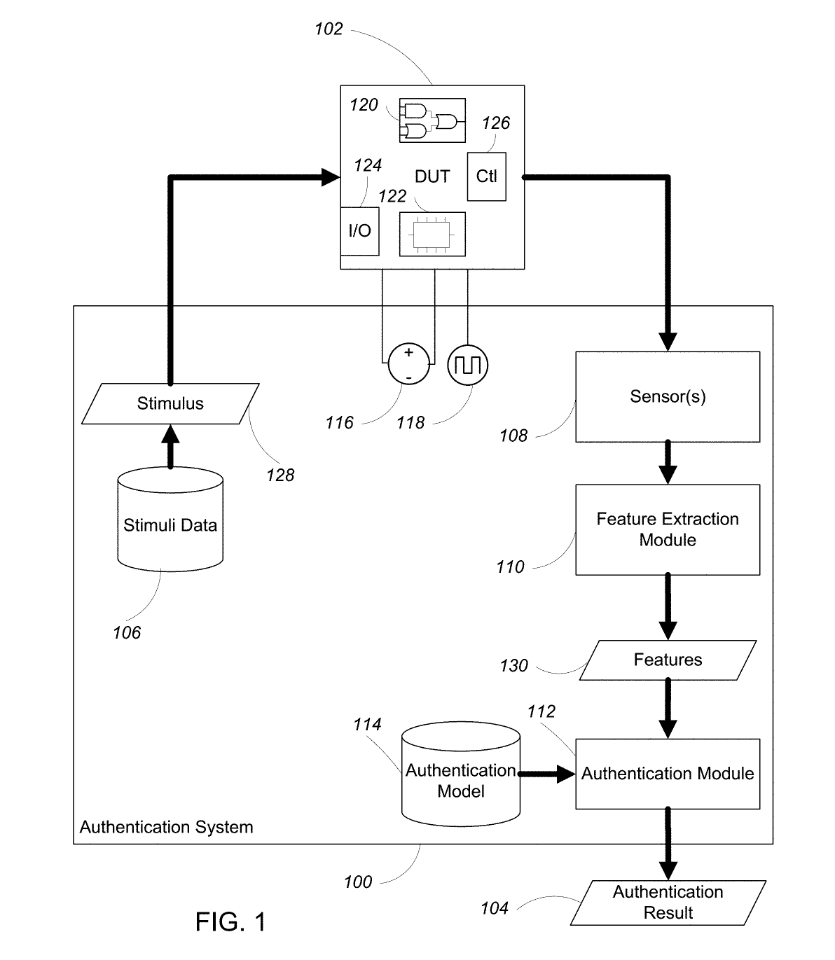

Referring to FIG. 1, an authentication system 100 is configured to stimulate a device under test (DUT) 102, measure a side-channel (or side-effect) response of the DUT 102 to the stimulus, and to to determine an authentication result 104 indicating whether the DUT 102 is authentic based on the side-channel response of the DUT 102. It is noted that, in the context of this application, a device that is deemed to be “authentic” excludes devices that are counterfeit, including remarked devices, reproduced devices, “cloned” devices, and recycled devices that have been used in prior systems. Likewise, counterfeit or “non-authentic” devices include remarked devices, reproduced devices, “cloned” devices, and recycled devices that have been used in prior systems.

The authentication system 100 includes a stimuli data store 106, one or more sensors 108, a feature extraction module 110, an authentication module 112, an authentication model data store 114, a power supply 116, and a clock 118.

In general, the DUT 102 is an active, configurable semiconductor device in which a functionality of the device depends on a configuration of the DUT 102. Some examples of active, configurable devices include FPGAs, PLAs, microcontrollers, microprocessors, digital signal processing chips, among other examples. In general, the DUT will include one more of logic circuitry 120, memory/register circuitry 122, input/output circuitry, control circuitry 126, and the like.

In operation, the authentication system 100 provides power from the power supply 116 and in some cases a clock signal from the clock 118 to the DUT 102. The authentication system 100 also selects a stimulus 128 from the stimuli data store 106 and configures the DUT 102 according to the selected stimulus 128.

Once configured with the stimulus 128, the DUT 102 operates according to the stimulus 128, the provided power, and the provided clock. As the DUT 102 operates according to the stimulus 102, the sensors 108 measure side-channel information associated with the operation the DUT 102. In the example described below, the sensors 108 measure side-channel information associated with the power used by the DUT 102 as it operates according to the stimulus 128.

The side-channel information measured by the sensors 108 is provided to the feature extraction module 110 which extracts one or more features 130 from the side-channel information. As is described in greater detail below, the one or more features 130 associated with measured power side-channel information include an instantaneous amplitude, instantaneous phase, and instantaneous frequency of the measured power information and a number of statistical moments of those features.

The features 130 extracted by the feature extraction module 110 are provided to the authentication module 112 along with the authentication model 114. In general, the authentication model 114 includes a representation of features associated with a number of other instances of the DUT 102 that are known to the authentic (and/or non-authentic). The authentication module 112 processes the features 130 according to the authentication model 114 to determine an authentication result 104 including a degree of authenticity of the DUT 102.

### 2Stimulus

In general, the stimulus is designed to exercise one or more specific circuit regions or functions (e.g., all XOR gates, all lookup tables, or all asynchronous units) in a way that causes side-channel features or characteristics (e.g., an emission or absorption of energy) to occur. For example, the operations for exercising a mixture of arithmetic, register, and memory operation on the device are carefully defined such that an impact of manufacturing artifacts inherent to the device are maximized and that as much of the logic circuitry present on the DUT 102 is exercised. In some examples, the stimulus is designed to stress transistor switching performance to reveal effects of synchronous and asynchronous activity and to reveal any skew rates and responsiveness characteristics that are impacted by manufacturing artifacts.

In one example, the stimulus is designed as a program which executes a number of iterations (e.g., 1000 iterations) of an operational loop that includes operations for exercising a mixture of arithmetic, register, and memory operation on the device. In one example, each iteration of the operational loop requires a number (e.g., 25-100) of individual clock cycles, where the clock 118 provided to the DUT 102 is an external pulse generator generate pulses with a frequency of 10 MHz. In some examples, using an external pulse generator to clock the DUT 102 prevents timing inconsistencies that may occur when using a factory calibrated clock.

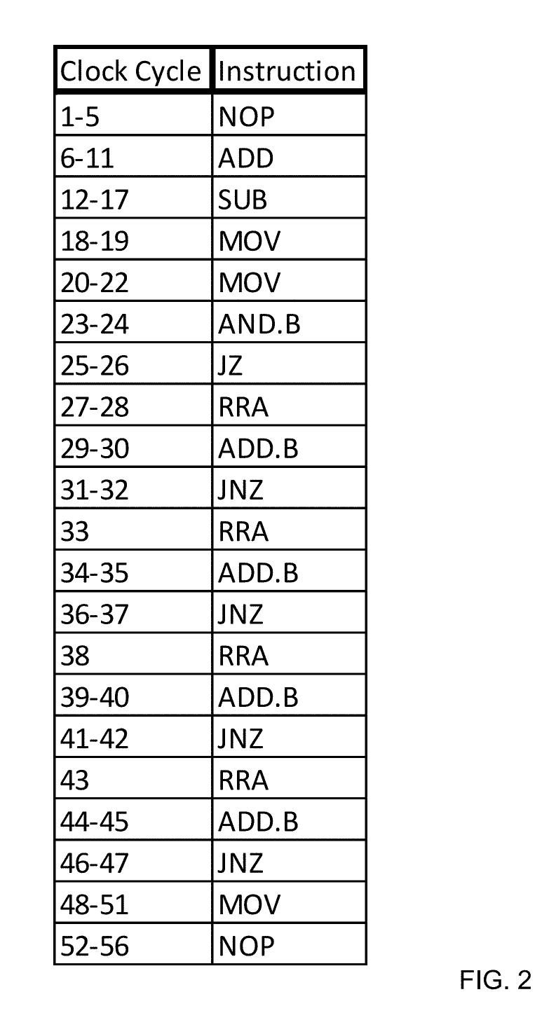

Referring to FIG. 2, in one example, each iteration of the operational loop spans 56 clock cycles, with each clock cycle associated with at most one operation. Ten of the clock cycles (five at the beginning and five at the end) are associated with no-operations (i.e.,NOPs) to allow time for circuit settling at the beginning and end of the operational loop. Clock cycles 1-5 are NOPs associated with raising an external trigger, causing the sensors 108 to measure side-channel information from the DUT 102 for the present iteration of the operational loop. Clock cycles 52-56 are NOPs which indicate an end of the iteration, causing the sensors 108 to stop measuring side-channel information from the DUT 102 for the iteration. Clock cycles 6-51 are associated with a number of arithmetic and memory operations.

### 3 Sensors

In some examples, the sensors 108 include custom sensing circuits which output signals representing a peak power used by the DUT 102. In some examples, the signals representing an operation power of the DUT 102 are captured on an oscilloscope for subsequent use.

As is noted above, the sensors 108 are activated to measure side-channel information from the DUT 102 during the clock cycles of the operational loop. In some examples, the sensors 108 are configured to measure operation power of the DUT 102 for the individual clock cycles of the operational loop. For example, for each of the clock cycles of the operational loop, a number of samples of operation power data are generated. In some examples, 125 samples of operation power data are generated per clock cycle. In some examples, a sample rate for collection of operation power data is 1.25 GSamples per second.

### 4 Feature Generation Module

Referring again to FIG. 1, the operation power data collected by the sensors 108 is processed by the feature extraction module 110 to generate a number of features 130.

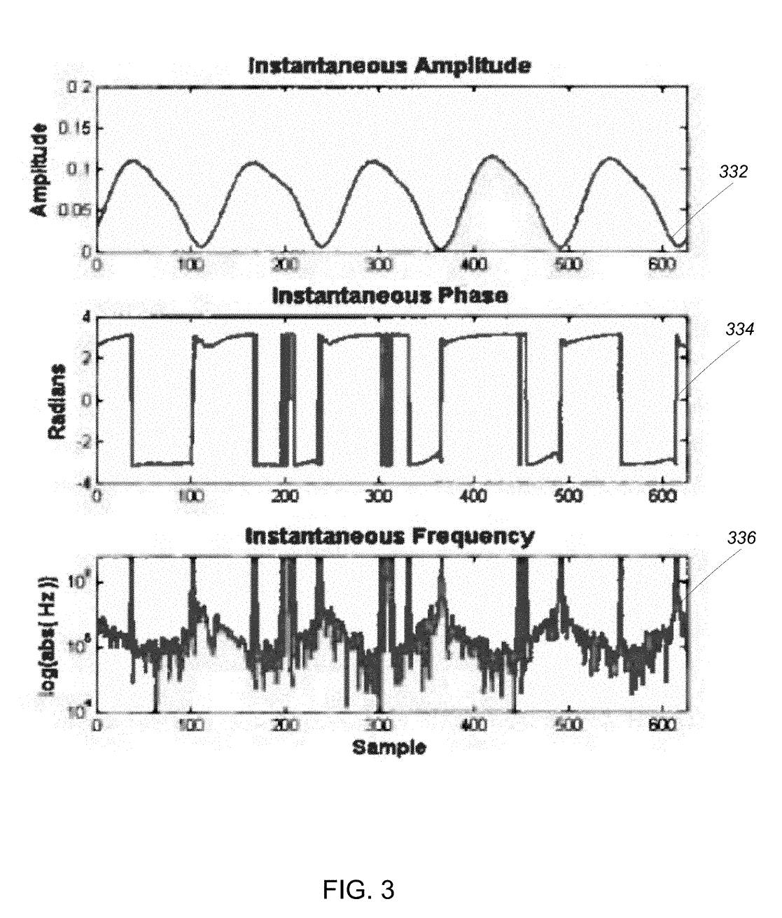

In some examples, the operation power data collected by the sensors 108 includes an operation power signal for the DUT 102, which is in some cases segmented by clock cycle. Referring to FIG. 3, the feature extraction module 110 transforms each segment of the operation power signal into a corresponding Hilbert analytical signals from which the instantaneous amplitude 332, instantaneous phase 336, and instantaneous frequency 338 are derived. The feature extraction module 110 also determines the first four statistical moments (i.e., the mean, variance, kurtosis, and skewness) from each of these waveforms. The feature extraction module 110 also transforms the entire operation power signal into a Hilbert analytical signal and determines the instantaneous amplitude, instantaneous phase, and instantaneous frequency for that signal. The first four statistical moments are also extracted from each of these waveforms.

In some examples, the above-described analysis generates a large number of features (e.g., hundreds or thousands of features), where each individual feature is considered a dimension of information. However, a number of the features are often highly correlated. In some examples, steps are taken to reduce the number of features used to determine the authentication result 104. Such a reduction in features leads to more accurate classification decisions and a simplified methodology

For example, principal component analysis can be used to project the features to a lower dimensionality using Principal Components Analysis (PCA). For example, PCA can be used to project down to 3 principal components to avoid overfitting, which typically explains more than 60% of variance.

In some examples, features that contribute the most towards correct classification decisions are identified. For example, certain features that are closely related to manufacturing process variation differences or other physical phenomena are identified as contributing to a device's intrinsic side-channel characteristics. In some examples, a Multiple Cluster Feature Selection algorithm is used to generate ordered lists of features according to their contribution to a given comparison.

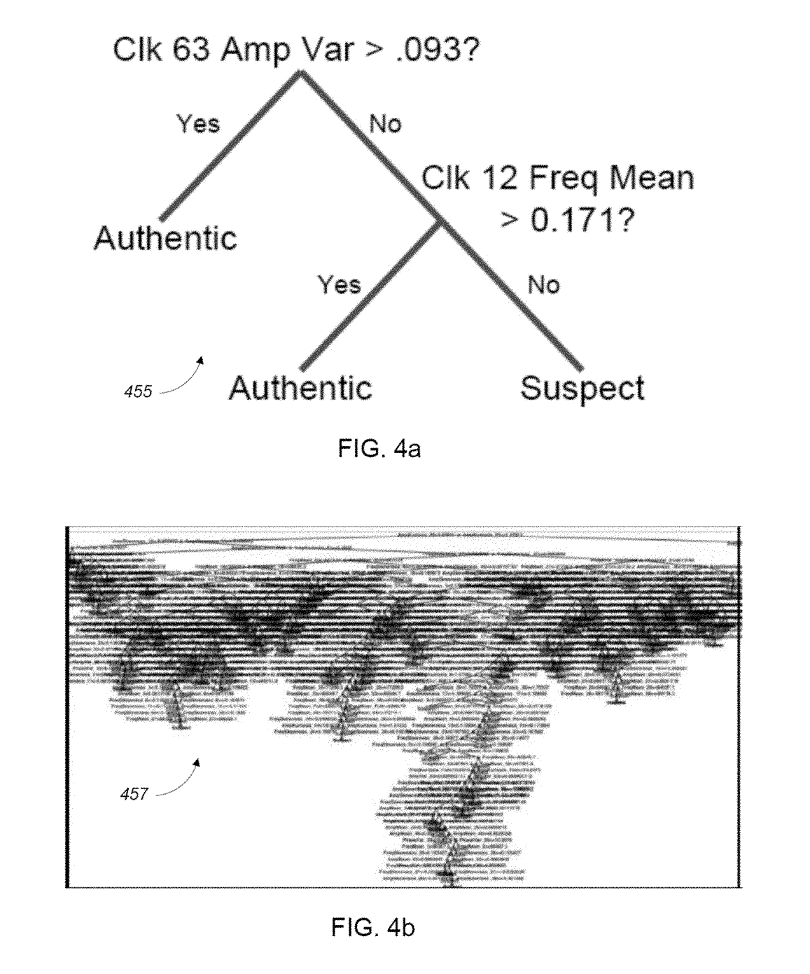

In other examples, the number of dimensions of information is reduced using a two-step approach which first removes highly-correlated features by performing a pairwise comparison (e.g., anything with a Pearson correlation coefficient greater than 0.9 is removed). Referring to FIG. 4a and FIG. 4b, in the second step a Decision Tree learning approach, which aims to derive a classification model based on minimizing entropy and defining thresholds on the observed features, is performed. For the case of counterfeits, comparing a counterfeit device with a golden model could result in relatively few necessary features (see the decision tree 455 of FIG. 4a) to define a set of decisions about whether new samples would be non-authentic or authentic. In the other case of authentic vs. authentic, the model may result in a tree with many features and be fairly complex (see the decision tree 457 of FIG. 4b). In some examples, the features utilized in the decision tree are used as input to a classification system. In some examples, either step of the two-step approach can be used alone (i.e., without the other step).

### 5 Authentication Module

Referring again to FIG. 1 the features 130 output from the feature extraction module 110 and the authentication model 114 are provided to the authentication module 112. In some examples, the authentication module 112 includes a support vector machine (SVM) classifier. Very generally, the support vector machine (SVM) classifier is configured to separate a “golden” (e.g., authentic) set of observations from other groups of observations. In the authentication system of FIG. 1, the support vector machine of the authentication module 112 is configured to classify the DUT 102 as either authentic or non-authentic based on a comparison of the observed features 130 and the authentication model 114 (which is described in greater detail below).

In some examples, the authentication result 104 is simply an indication as to whether the DUT 102 is authentic or non-authentic. In other examples, however the authentication result 104 includes a confidence level associated with the result. For example, the authentication result 104 may indicate that the device is authentic with a 78% confidence.

In some examples, when the authentication model 114 has been trained with both known authentic devices and known non-authentic devices, the authentication module 112 is configured to classify the DUT 102 into one of two classes (i.e., authentic or non-authentic). However, in some examples, when the authentication model 114 is trained with only authentic devices, the authentication module 112 is configured to determine whether or not the DUT 102 belongs to a single ‘authentic’ class. That is, the authentication module 112 is essentially a significance test. In other examples, the authentication module 112 is configured to classify the DUT 102 into one of several (i.e., three or more) classes, a naïve Bayes classifier is used to perform the classification. Other examples of algorithms for processing the features 130 to determine the authentication result 104 include but are not limited to linear discriminant analysis (LDA), multiple discriminant analysis (MDA), spectral regression discriminant analysis (SRDA), random forests, and isolation forests.

### 6 Authentication Model Training

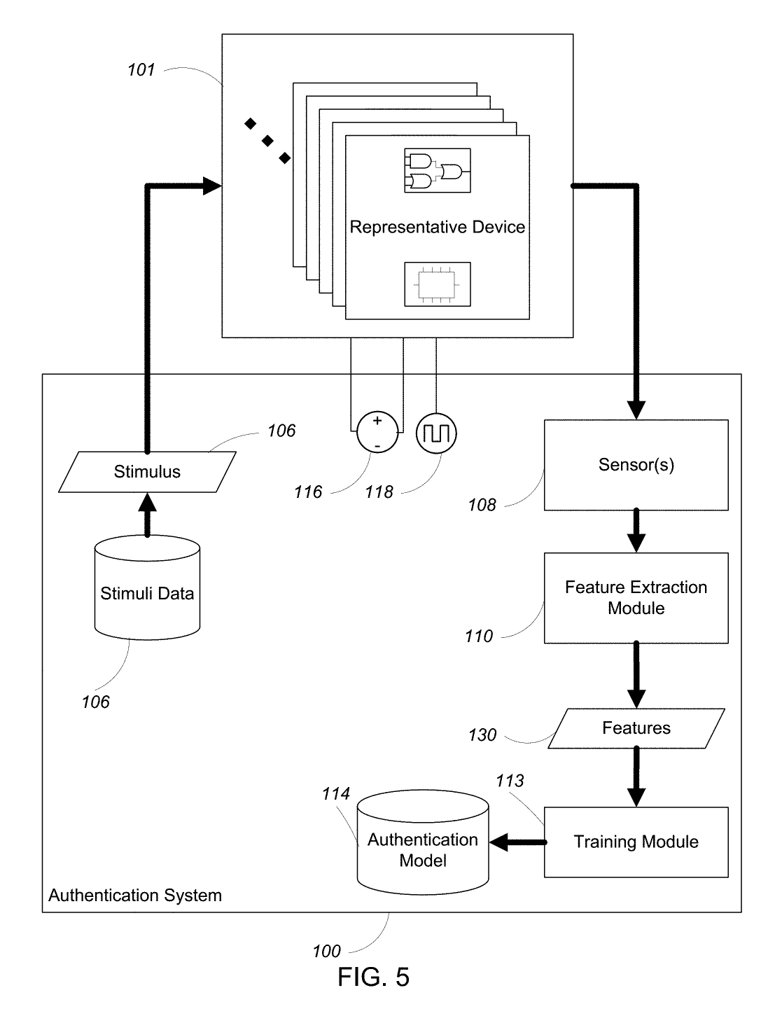

Referring to FIG. 5, in a training configuration the authentication system 100 performs the stimulation and feature extraction procedure described above for a number of representative devices 101 with known authenticities. The features extracted for the number of representative devices 101 are used in a training procedure to form the authentication model 114.

In particular, for each of the representative devices 101, the authentication system 100 provides power from the power supply 116 and a clock signal from the clock 118 to the representative device 101. The authentication system 100 also selects a stimulus 128 from the stimuli data store 106 and configures the representative device 101 according to the selected stimulus 128.

Once configured with the stimulus 128, the representative device 101 operates according to the stimulus 128, the provided power, and the provided clock. As the representative device 101 operates according to the stimulus 102, the sensors 108 measure side-channel information associated with the operation the representative device 101. For example, the sensors 108 measure side-channel information associated with the power used by the representative device 101 as it operates according to the stimulus 128.

The side-channel information measured by the sensors 108 is provided to the feature extraction module 110 which extracts one or more features 130 from the side-channel information. The one or more features 130 associated with measured power side-channel information include an instantaneous amplitude, instantaneous phase, and instantaneous frequency of the measured power information and a number of statistical moments of those features.

The features 130 extracted by the feature extraction module 110 are provided to the training module 113 which performs a supervised learning procedure to generate the authentication model 114.

In some examples, to reduce the possibility of temporary environmental factors affecting the model training procedure, features 130 were collected for the representative devices 101 at a number of different times (e.g. on three separate dates). In some examples, the features are analyzed separately to identify features that provide misleading information.

In some examples, as additional devices with known authenticity become available, a re-training or (re-calibration) can be performed to update the authentication model 114 according to features from the additional devices. For example, over time a number of additional devices may be received and classified as either being authentic or non-authentic according to an authenticity model for the particular device. In some examples, it may be discovered (e.g., by destructive analysis) that at least some of the additional devices are being incorrectly classified. The additional devices and their known authenticity can be used by the training module 113 to update the authentication model 114 for the particular device.

### 7 Alternatives

In some examples, the stimulus (i.e., the configuration data used to configure the DUT) is defined as an FPGA configuration file, a firmware configuration file, a set of configuration bits, machine readable compiled source code, software instructions, and the like.

While embodiments described above use power based side-channel information to distinguish authentic devices from non-authentic devices, it is noted that other types of side-channel information can be used to distinguish devices including but not limited to heat based side-channel information, electromagnetic (e.g., radio frequency) emission side-channel information, timing based side-channel information, acoustic emission side-channel information, and so on.

In the examples described above, training of the model is performed using devices of known authenticity and the model is trained using a supervised learning algorithm. It is noted, however that in some examples the devices may not have known authenticity and unsupervised learning may be used to determine different groups of related devices. A sampling of devices from each of the groups of related devices can then be used to determine an authenticity associated with each of the groups.

In some examples, a non-authentic part can be distinguished from an authentic part based on a variance of one or more measured features.

In some examples, the stimulus data store includes a number of stimuli corresponding to a number of different devices. The authentication system is configured to receive an identification of the device under test and selects an appropriate stimulus for the device under test. In some examples, the stimuli data store is a database maintained at a centralized, remote location that is accessible to the authentication system (e.g., via the internet).

In some examples, the techniques described herein can be used to detect properties other than an authenticity of electronic devices. For example, the techniques can be used to determine whether an electronic device includes leaded components (e.g., lead solder).

In some examples, the authentication system generates a ranked probability list of matches for a particular DUT. For example, given a database of authentication models for different devices, the authentication system classifies the DUT according to the authentication models for at least some of the different devices and generates a list of possible classifications for the DUT with associated degrees of confidence (e.g., Chip X 60% confidence, Chip Y 33% confidence, Chip Z 24% confidence).

It is to be understood that the foregoing description is intended to illustrate and not to limit the scope of the invention, which is defined by the scope of the appended claims. Other embodiments are within the scope of the following claims.

What is claimed is:

1. A method for determining an authenticity of a configurable electronic device, the method comprising:
configuring the configurable electronic device according to stimulus data;
measuring one or more side-effects of operation of the configurable electronic device after configuration of the electronic device to generate representations of the one or more side-effects;
processing the representations of the side-effects using a feature extraction module to determine one or more features characterizing the representations of the side-effects; and
processing the one or more features characterizing the representations of the side-effects using an authentication module to determine a degree of authenticity of the configurable electronic device.

2. The method of claim 1 wherein the authentication module is configured to determine the degree of authenticity of the configurable electronic device according to corresponding features characterizing the representations of the side-effects of one or more other configurable electronic devices with known degrees of authenticity.

3. The method of claim 2 further comprising training the authentication module including:
configuring the one or more other configurable electronic devices according to the stimulus data;
measuring one or more side-effects of operation of the one or more other configurable electronic devices to generate corresponding representations of the side-effects;
processing the corresponding representations of the side-effects using the feature extraction module to determine features characterizing the corresponding representations of the side-effects, and
configuring the authentication module according to the features characterizing the corresponding representations of the side-effects and the known degrees of authenticity associated with the one or more other configurable electronic devices.

4. The method of claim 1 wherein the authentication module includes a classifier configured to classify the configurable electronic device as being either authentic or inauthentic.

5. The method of claim 1 wherein the degree of authenticity includes an indication of a confidence that the configurable electronic device is authentic.

6. The method of claim 1 wherein the feature extraction module is configured to extract a first set of features characterizing the representations of the side-effects and to determine the one or more features characterizing the representations of the side-effects as a subset of the first set of features.

7. The method of claim 6 wherein the subset of the first set of features is determined by performing one or both of principal component analysis and a multiple cluster feature selection on the first set of features.

8. The method of claim 1 wherein the representations of the one or more side-effects includes a power signal representing an operating power of the configurable electronic device.

9. The method of claim 8 wherein the feature extraction module is configured to extract a first set of features characterizing the power signal and to determine the one or more features characterizing the power signal as a combination of features from the first set of features.

10. The method of claim 9 wherein the one or more features characterizing the power signal include one or more of:
an instantaneous frequency of some or all of the power signal, a mean instantaneous frequency of some or all of the power signal, a variance of the instantaneous frequency of some or all of the power signal, a kurtosis of the instantaneous frequency of some or all of the power signal, and a skewness of the instantaneous frequency of some or all of the power signal,
an instantaneous amplitude of some or all of the power signal, a mean instantaneous amplitude of some or all of the power signal, a variance of the instantaneous amplitude of some or all of the power signal, a kurtosis of the instantaneous amplitude of some or all of the power signal, and a skewness of the instantaneous amplitude of some or all of the power signal,
an instantaneous phase of some or all of the power signal, a mean instantaneous phase of some or all of the power signal, a variance of the instantaneous phase of some or all of the power signal, a kurtosis of the instantaneous phase of some or all of the power signal, and a skewness of the instantaneous phase of some or all of the power signal.

11. The method of claim 1 wherein configuring the configurable electronic device according to the stimulus data includes configuring the configurable electronic device to perform a plurality of operations.

12. The method of claim 11 wherein the plurality of operations includes some or all of memory operations, register operations, and logic operations.

13. The method of claim 11 wherein configuring the configurable electronic device to perform the plurality of operations includes configuring the configurable electronic device to perform a predefined number of iterations of a first set of operations.

14. The method of claim 1 wherein configuring the configurable electronic device according to the stimulus data includes provisioning the configurable electronic device according to a hardware configuration specification.

15. The method of claim 1 wherein one or more side-effects of operation of the configurable electronic device include temperature based side-effects.

16. The method of claim 1 wherein the one or more side-effects of operation of the configurable electronic device include electromagnetic based side-effects.

17. The method of claim 1 further comprising receiving the stimulus data from a remotely located, centralized stimulus data server.

18. The method of claim 1 wherein the one or more other configurable electronic devices are known to be authentic.

19. The method of claim 18 wherein the authentication module includes a one-class support vector machine trained according to the one or more other configurable electronic devices.

20. A system for determining an authenticity of a configurable electronic device, the system comprising:
an input for receiving stimulus data;
an interface for configuring the configurable electronic device according to the stimulus data;
on or more sensors for measuring one or more side-effects of operation of the configurable electronic device after configuring the electronic device to generate representations of the one or more side-effects;
a feature extraction module for processing the representations of the side-effects to determine one or more features characterizing the representations of the side-effects; and
an authentication module for processing the one or more features characterizing the representations of the side-effects to determine a degree of authenticity of the configurable electronic device.
